(19) United States
(12) Patent Application Publication
(10) Pub. No.: US 2024/0388322 A1
(43) Pub. Date: Nov. 21, 2024

(54) WIRELESS SERIAL CONNECTION COMMUNICATION SYSTEM AND ANTENNA MODULE THEREOF

(71) Applicant: Grace Connection Microelectronics Limited, Zhubei City (TW)

(72) Inventors: Pei Wei Chen, Zhubei City (TW); Sheng Wei Guan, Zhubei City (TW)

(73) Assignee: Grace Connection Microelectronics Limited, Zhubei City (TW)

(21) Appl. No.: 18/590,864

(22) Filed: Feb. 28, 2024

(30) Foreign Application Priority Data
May 16, 2023 (TW) 112118073

(51) Int. Cl. H04B 5/48; H04B 5/72; H04B 5/75

(52) U.S. Cl. CPC H04B 5/48; H04B 5/72; H04B 5/75

(57) ABSTRACT

A wireless serial connection communication system, including: a first circuit board, including a first antenna module which includes a first front wireless communication terminal and a first rear wireless communication terminal; and a second circuit board, disposed adjacent to the first circuit board, the second circuit board including a second antenna module which includes a second front wireless communication terminal and a second rear wireless communication terminal. The first rear wireless communication terminal is face to face adjacent to the second front wireless communication terminal. The first front wireless communication terminal and the second rear wireless communication terminal are respectively disposed on farther sides over the first and second circuit boards, with reference to the first rear wireless communication terminal and the second front wireless communication terminal. By an antenna operation between the first circuit board and the second circuit board, a first wireless signal connection is built between the first rear wireless communication terminal and the second front wireless communication terminal.

### CROSS REFERENCE

The present invention claims priority to TW112118073, filed on May 16, 2023.

### BACKGROUND OF THE INVENTION

### Field of Invention

The present invention provides a wireless serial connection communication system, especially a wireless serial connection communication system with an innovative antenna module design. The wireless serial connection communication system is provided for a daisy-chain battery management system based on a special communication operation among multiple circuit boards, formed by a special antenna design of the wireless communication terminal.

### Description of Related Art

In the current signal management system for managing plural stacked or side-by-side electronic devices (for example, the signal management system for the electronic devices, each of which includes a battery unit to be serially connected for power supply), the signal connection between the electronic devices is often built by a wired daisy chain structure, and the signal transmission is operated sequentially according to the connection order of the electronic devices in the wired connection. However, the wired connection arrangement often comes to long wires, and the high impedance of the long wires often consume high power during the signal transmission. In addition, if some of the electronic devices in the wired daisy-chain connection are to be repaired or relocated, the complex wire configuration of the wired daisy-chain connection brings difficult wiring management easily into an error-prone status.

When wireless signals can be used between the electronic devices, it can avoid the problems of high impedance and complex wiring management. However, conventional wireless signal transmission methods is preferred a broadcasting technique, which is difficult to transmit signal to specific location or limit the transmission of wireless signals only between appointed electronic devices.

In view of these, how to control a wireless communication only between specific battery cells in the wireless battery management system, such that the electronic devices can communicate through the precise wireless communication, without wires. This signal management can be simple and clear to sequentially transmit and receive wireless signal between the stacked or side-by-side located electronic devices, such as battery cells in the wireless daisy-chain battery management system, according to the position proximity between the electronic devices.

### SUMMARY OF THE INVENTION

In view of the above, the present invention provides a wireless serial connection communication system, which includes: a first circuit board, including a first antenna module with a first front wireless communication terminal and a first rear wireless communication terminal; and a second circuit board, disposed adjacent to the first circuit board, the second circuit board including a second antenna module with a second front wireless communication terminal and a second rear wireless communication terminal. The first rear wireless communication terminal is side to side adjacent to the second front wireless communication terminal. The first front wireless communication terminal and the second rear wireless communication terminal are respectively disposed on farther sides over the first and second circuit boards, with reference to the first rear wireless communication terminal and the second front wireless communication terminal. By an antenna operation between the first circuit board and the second circuit board, a first wireless signal connection is built between the first rear wireless communication terminal and the second front wireless communication terminal, and the first wireless signal connection is regulated to be the only wireless signal connection between the first circuit board and the second circuit board.

According to one embodiment of the antenna operation, in the first wireless signal connection by the antenna operation, neither the second antenna module nor the first rear wireless communication terminal has wireless signal connection with the first front wireless communication terminal. And, neither the first antenna module nor the second front wireless communication terminal has wireless signal connection with the second rear wireless communication terminal.

According to one embodiment of the antenna operation, in the first wireless signal connection by the antenna operation, a wireless transmission level between the first front wireless communication terminal and the second antenna module, a wireless transmission level between the first front wireless communication terminal and the first rear wireless communication terminal, a wireless transmission level between the second rear wireless communication terminal and the first antenna module, and a wireless transmission level between the second rear wireless communication terminal and the second front wireless communication terminal, are all lower than a first wireless signal transmission level between the first rear wireless communication terminal and the second front wireless communication terminal at least in a scale of a level threshold, wherein the level differences between the wireless transmission levels and the first wireless signal transmission level (or, level threshold) confines the first wireless signal connection to be the only wireless signal connection between the first circuit board and the second circuit board.

In one embodiment, each of the first and second circuit boards includes a signal isolation module or a signal level regulation unit. The signal level regulation unit includes a transmission strength regulation unit, for gradually increasing a signal transmission strength between the first rear wireless communication terminal and the second front wireless communication terminal, until the first wireless signal connection is (just) determined or regulated to be the only wireless signal connection between the first rear wireless communication terminal and the second front wireless communication terminal (or, the first wireless signal connection is only connected between the first rear wireless communication terminal and the second front wireless communication terminal), to secure the first front wireless communication terminal and the second rear wireless communication terminal against being connected to the first wireless signal connection.

In one embodiment, the signal level regulation unit includes a signal-to-noise ratio adjustment unit, for gradually increasing the signal-to-noise ratio for receiving the first wireless signal by each of the wireless communication terminals (since a low signal-to-noise ratio) for receiving the wireless signal, until the first wireless signal connection is built between the first rear wireless communication terminal and the second front wireless communication terminal, to secure the first front wireless communication terminal and the second rear wireless communication terminal against being connected to the first wireless signal connection.

In one embodiment, the wireless serial connection communication system, further includes a third circuit board. The third circuit board is disposed adjacent to the second circuit board, and includes a third antenna module with a third front wireless communication terminal and a third rear wireless communication terminal, wherein the second rear wireless communication terminal is disposed adjacent to the third front wireless communication terminal, and a second wireless signal connection is built between the second rear wireless communication terminal and the third front wireless communication terminal by the antenna operation. The first wireless signal connection and the second wireless signal connection can form a wireless daisy chain.

In one embodiment, each of the aforementioned wireless communication terminals in the aforementioned circuit boards, includes: a radiating portion, disposed at an edge (or, side) of each of the aforementioned circuit boards, the radiating portion including a comb-shaped portion for emitting and receiving an electric wave in a lateral direction of the aforementioned circuit board, to and from another radiating portion of an adjacent circuit board, in correspondence with a transmission control signal (the transmission control signal corresponding to the wireless signal, or corresponding to the signal controlling the transmitting of the wireless signal) in the aforementioned circuit board; or, the radiating portion including a loop antenna for emitting and receiving a magnetic wave in the lateral direction of the aforementioned circuit board, to and from another radiating portion of the adjacent circuit board, in correspondence with the transmission control signal in the aforementioned circuit board; and a signal isolation module, defining an effective transmission range between two adjacent wireless communication terminals to emit and receive the electric wave or the magnetic wave.

In one embodiment, the comb-shaped portion includes an extended linear feeder and a plurality of radiation fins connected to the extended linear feeder, each of the radiation fins includes a plurality of tips, and at least a portion of the tips of the radiation fins is disposed correspondingly to at least a portion of the plural tips in another radiation portion of the adjacent circuit board, for emitting and receiving the electric wave between the two radiation portions. In one embodiment, the loop antenna is formed by a plurality of loop wires located in different conduction layers in the aforementioned circuit board, and a plurality of loop pillars to form the loop antenna. The loop pillars respectively conducting the loop wires, to form a conductive loop structure. At least a portion of the loop antenna in the radiation portion, is disposed correspondingly to at least a portion of another loop antenna of the other radiating portion, to emit and receive the magnetic wave between the two radiation portions.

In one embodiment, the effective transmission range is in a form of a long and narrow range.

In one embodiment, the signal isolation module includes a layer plate structure, which is disposed in the circuit board and parallel to the comb-shaped portion, to determine the effective transmission range between the aforementioned wireless communication terminals to emit and receive the electric wave. In one embodiment, the signal isolation module includes a grid structure disposed on an inward-facing side of the radiation portion to the center of the circuit board. The signal isolation module includes two conduction layers (or a portion of the two conduction layers) in the circuit board and a plurality of shielding pillars MS44 conducting the conduction layers, to determine the effective transmission range between the aforementioned wireless communication terminals for emitting and receiving the magnetic wave.

In one perspective, the present invention provides a wireless serial connection communication system, which includes: a first circuit board, including a first wireless communication terminal; and a second circuit board, disposed adjacent to the first circuit board, and including a second wireless communication terminal; wherein the first wireless communication terminal is adjacent to the second wireless communication terminal, and each of the first and second wireless communication terminals includes: a radiating portion, disposed at an edge of each of the circuit boards, and including a comb-shaped portion for emitting and receiving an electric wave in a lateral direction of the aforementioned circuit board (a direction perpendicular to a normal direction of a top surface of the circuit board), to and from another radiating portion of an adjacent circuit board, in correspondence with a transmission control signal; or, the radiating portion including a loop antenna for emitting and receiving a magnetic wave in the lateral direction of the circuit board, to and from another radiating portion of the adjacent circuit board, in correspondence with the transmission control signal; and a signal isolation module, defining an effective transmission range between two adjacent wireless communication terminals to emit and receive the electric wave or the magnetic wave, wherein the effective transmission range is essentially between the first wireless communication terminal on the first circuit board and the second wireless communication terminal on the second circuit board.

For better understanding the above and other aspects of the present invention, the detailed description of the embodiments and the accompanying drawings are provided as follows.

### BRIEF DESCRIPTION OF THE DRAWINGS

FIGS. 1, 2, and 3 respectively show several schematic drawings of the wireless daisy-chain serial connection communication systems according to multiple embodiments of the present invention.

FIGS. 4A, 4B, and 4C respectively show several schematic drawings of the circuit board and the wireless communication terminal therein in different view directions according to one embodiment of the present invention.

FIGS. 5A, 5B, 5C, and 5D respectively show several schematic drawings of the circuit board and the wireless communication terminal of the antenna module in different view directions according to one embodiment of the present invention.

FIGS. 6A, and 6B respectively show several schematic drawings of disposition arrangement of the circuit boards and the batteries in a daisy-chain battery management system according to two embodiments of the present invention.

### DESCRIPTION OF THE PREFERRED EMBODIMENTS

The objectives, technical details, features, and effects of the present invention will be better understood with regard to the further detailed description of the embodiments below, with reference to the drawings. Obviously, the described embodiment is only a part of the present invention, rather than all.

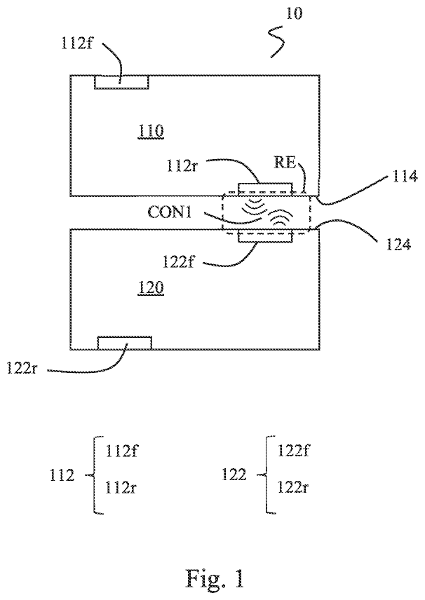

In view of the above technical needs, as shown in FIG. 1, the present invention provides a wireless daisy-chain serial connection communication system 10, which includes: a first circuit board 110 corresponding to a first battery cell (not shown), including a first antenna module 112 which includes a first front wireless communication terminal 112f and a first rear wireless communication terminal 112r; and a second circuit board 120 corresponding to a second battery cell (not shown), disposed adjacent to (or, next to) the first circuit board 110, the second circuit board 120 including a second antenna module 122 which includes a second front wireless communication terminal 122f and a second rear wireless communication terminal 122r. The first rear wireless communication terminal 112r is correspondingly (one-on-one) adjacent to the second front wireless communication terminal 122f. That is, a rear wireless communication terminal of one antenna module is always correspondingly (one-on-one) near to a front wireless communication terminal of sequentially next another adjacent antenna module. The first front wireless communication terminal 112f and the second rear wireless communication terminal 122r are respectively disposed on farther sides over the first and second circuit boards (110 and 120), with reference to the adjacent sides of the first rear wireless communication terminal 112r and the second front wireless communication terminal 122f. By an antenna operation between the first circuit board 110 and the second circuit board 120, a first wireless signal connection CON1 is only built between the first rear wireless communication terminal 112r and the second front wireless communication terminal 122f, and the first wireless signal connection CON1 is set and regulated to be the only wireless signal connection between the first circuit board 110 and the second circuit board 120.

In one embodiment of the first wireless signal connection CON1 by the antenna operation, neither the second antenna module 122 nor the first rear wireless communication terminal 112r has wireless signal connection with the first front wireless communication terminal 112f, and neither the first antenna module 112 nor the second front wireless communication terminal 122f has wireless signal connection with the second rear wireless communication terminal 122r. The first wireless signal connection CON1 is regulated to be the only wireless signal connection between the first circuit board 110 and the second circuit board 120. In this way, there is no operational signal connection between non-adjacent wireless communication terminals in the present invention, which is totally different from the broadcasting communication technique. On stacked or parallel circuit boards (for example, circuit boards in each battery cell of the daisy-chain battery management system), the disposition sequence can determine the wireless signal sequence management, to enable the wireless signal management according to the circuit board arrangement. The innovative technology provided by the present invention, can achieve it by limiting the effective transmission range or level of the wireless signals. In further embodiments of the present invention, the related detail of the present invention is elaborated.

Keeping referring to FIG. 1, in another point of view, by the antenna operation, the first front wireless communication terminal 112f has no wireless signal connection with the second front wireless communication terminal 122f; the first rear wireless communication terminal 112r has no wireless signal connection with the second rear wireless communication terminal 122r; and the first front wireless communication terminal 112f has no wireless signal connection with the second rear wireless communication terminal 122r. Thus, the wireless management can be sequentially carried out according to the disposition sequence of the circuit boards, to secure that the wireless connection between the circuit boards (or, the antenna modules) against becoming tree-like or mesh-like wireless connection to other circuit boards, which can cause the problem of identifying the disposition sequence of the circuit boards. In the present invention, the wireless communication terminals form a signal connection of a wireless daisy chain.

For wireless signal management purpose, in one embodiment, when receiving the first wireless signal connection CON1 by one wireless communication terminal, a signal level isolation of the first wireless signal connection CON1 from other wireless communication terminals is very important. For example, by the antenna operation, a wireless transmission level between the first front wireless communication terminal 112f and the second antenna module 122, a wireless transmission level between the first front wireless communication terminal 112f and the first rear wireless communication terminal 112r, a wireless transmission level between the second rear wireless communication terminal 122r and the first antenna module 112, and a wireless transmission level between the second rear wireless communication terminal 122r and the second front wireless communication terminal 122f, are all lower than a first wireless signal transmission level between the first rear wireless communication terminal 112r and the second front wireless communication terminal 122f on a scale of more than a level threshold (for example, 20 dBw, or other level thresholds). This higher scale of the first wireless signal transmission level confines the first wireless signal connection CON1 to be the only wireless signal connection between the first circuit board 110 and the second circuit board 120. Or, in a different point of view, the level threshold can differentiate the transmission capabilities between these wireless transmission levels and the first wireless signal transmission level. That is, the first wireless signal connection CON1 between the first and second circuit boards (110, 120) is transmitted with a higher level of the level threshold, which clearly isolates other wireless communication terminals from the first wireless signal connection CON1, making other wireless communication terminals incapable of receiving the wireless signal via the first wireless signal connection CON1.

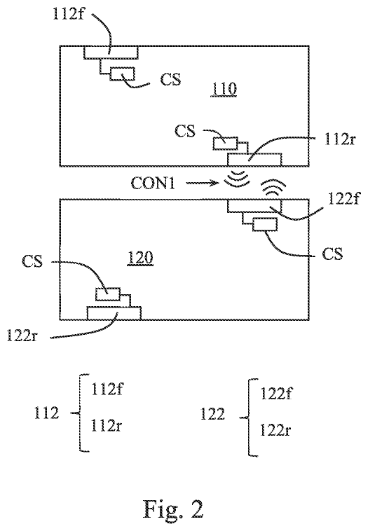

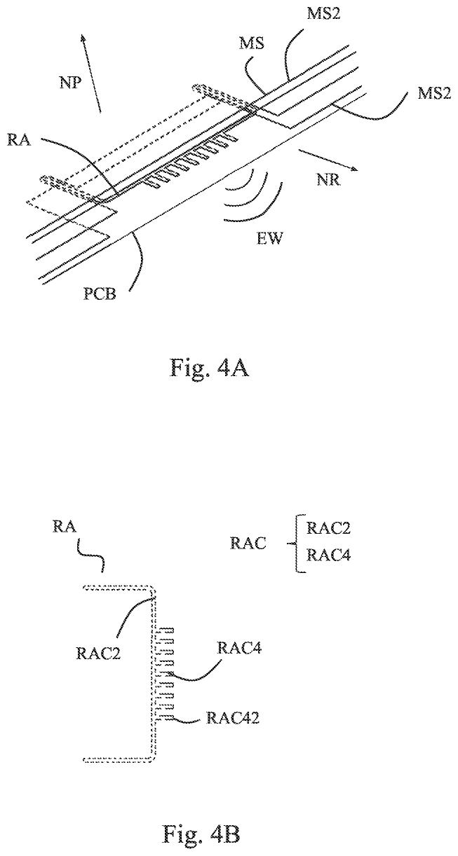

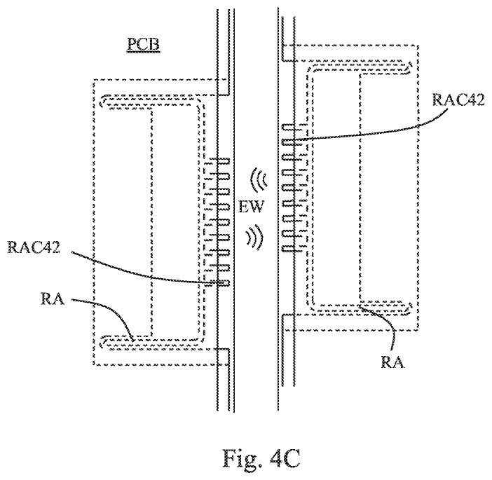

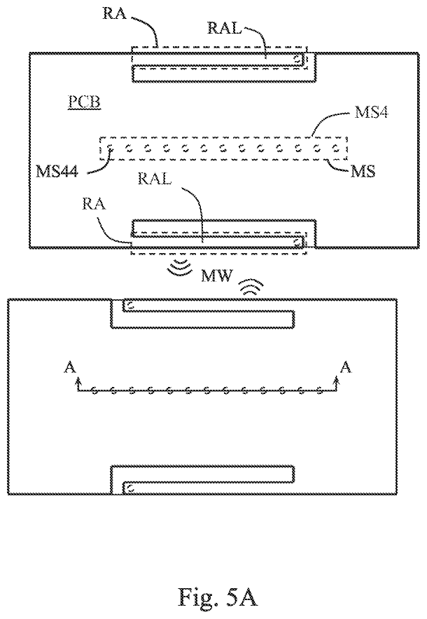

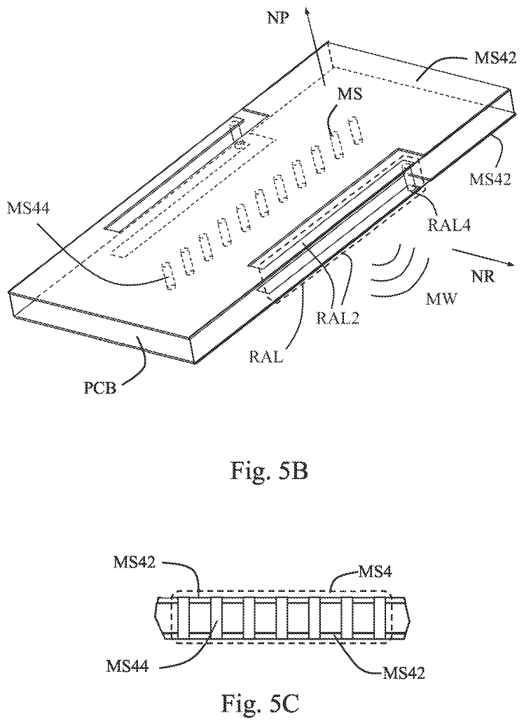

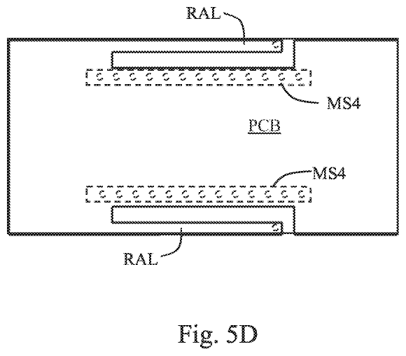

As shown in FIG. 2, in one embodiment, each of the first and second circuit boards (110 and 120), includes a signal level regulation unit CS or a signal isolation module MS (please refer to FIGS. 4A and 5A, and the detail of the embodiments referring to the drawings). The signal level regulation unit CS includes a transmission strength regulation unit, for gradually increasing a signal transmission strength between the first rear wireless communication terminal 112r and the second front wireless communication terminal 122f (since a very low signal transmission strength of no signal transmission), until the first wireless signal connection CON1 between the first rear wireless communication terminal 112r and the second front wireless communication terminal 122f is (just) established and determined. For example, via the first wireless signal connection CON1, the first rear wireless communication terminal 112r emits the wireless signal and the second front wireless communication terminal 122f receives the wireless signal. Or, the second front wireless communication terminal 122f emits the wireless signal and the first rear wireless communication terminal 112r receives the wireless signal. By this operation, when the adjacent wireless communication terminals have sufficient signal strength to communicate, the signal level is maintained and constrained without any further increase, to isolate the farther wireless communication terminal from communicating in the first wireless signal connection CON1. Thus, at the farther first front wireless communication terminal 112f and the farther second rear wireless communication terminal 122r, the signal level of the first wireless signal connection CON1 is not enough for signal communication. The first wireless signal connection CON1 can be maintained to be a one-on-one wireless signal connection between the wireless communication terminals (one wireless communication terminal to one wireless communication terminal communication).

In one embodiment, the signal level regulation unit CS includes a signal-to-noise ratio adjustment unit, for gradually increasing the signal-to-noise ratio for receiving the first wireless signal by each of the wireless communication terminals, until the first wireless signal connection CON1 is built between the first rear wireless communication terminal 112r and the second front wireless communication terminal 122f, to secure the first front wireless communication terminal 112f and the second rear wireless communication terminal 122r against being connected to the first wireless signal connection CON1. Thus, the first wireless signal connection CON1 is built between the first rear wireless communication terminal 112r and the second front wireless communication terminal 122f based on a lowest signal-to-noise ratio. Therein, this signal-to-noise ratio is just high enough to build the first wireless signal connection CON1 between the first rear wireless communication terminal 112r and the second front wireless communication terminal 122f. On the first front wireless communication terminal 112f and the second rear wireless communication terminal 122r of the farther sides, the signal-to-noise ratio received by the first front wireless communication terminal 112f and the second rear wireless communication terminal 122r is even lower (for example, signal-to-noise ratio decreases due to farther distance), such that the first front wireless communication terminal 112f and the second rear wireless communication terminal 122r cannot communicate with the first wireless signal connection CON1. Thus, the first wireless signal connection CON1 becomes the one-on-one signal connection between the wireless communication terminals.

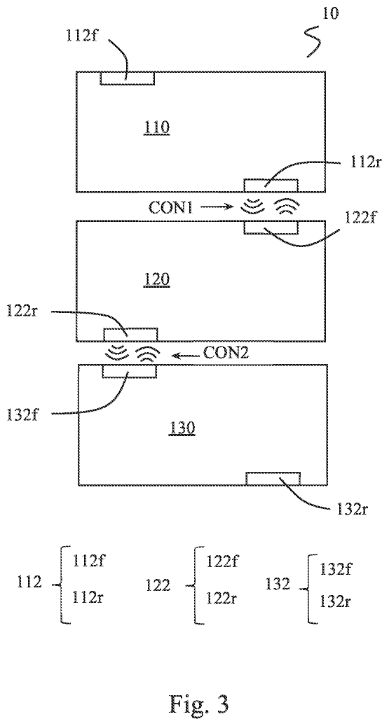

As shown in FIG. 3, in one embodiment, the wireless daisy-chain serial connection communication system 10, further includes a third circuit board 130 corresponding to a third battery cell (not shown). The third circuit board 130 is disposed adjacent to (or, next to) the second circuit board 120, and includes a third front wireless communication terminal 132f and a third rear wireless communication terminal 132r. The second rear wireless communication terminal 122r is disposed adjacent to the third front wireless communication terminal 132f, and a second wireless signal connection CON2 is built between the second rear wireless communication terminal 122r and the third front wireless communication terminal 132f by the antenna operation. The first wireless signal connection CON1 and the second wireless signal connection CON2 can form a wireless daisy-chain communication structure. According to this invention, the rear wireless communication terminal of each circuit board, can communicate with the front wireless communication terminal of another next adjacent circuit board by the wireless signal. Further, the present invention provides a one-on-one wireless serial connection between the circuit boards, by the antenna operation, rather than the tree-like or mesh-like connection in a point view of signal connection topology.

As shown in FIG. 4A, in one embodiment, each of the wireless communication terminals (for example, 112f, 112r, 122f, 122r, 132f, or 132r) in each of the circuit boards, includes: a radiating portion RA, disposed at a side of each of the circuit boards (for example, first circuit board 110, second circuit board 120, third circuit board 130, or other circuit boards). The radiating portion RA including a comb-shaped portion RAC (FIG. 4B) for emitting an electric wave EW in a lateral direction of the circuit board, to another radiating portion RA of an adjacent circuit board (FIG. 4C) in correspondence with a transmission control signal. Or, as shown in FIGS. 5A and 5B, the radiating portion RA including a loop antenna RAL that emits and receives a magnetic wave MW in the lateral direction of the circuit board, to and from another radiating portion RA of the adjacent circuit board (FIG. 5A), in correspondence with the transmission control signal; and a signal isolation module MS, defining an effective transmission range RE (FIG. 1) between two adjacent wireless communication terminals to emit and receive the electric wave EW or the magnetic wave MW. Therein, the present invention can provide corresponding wireless communication solutions between adjacent circuit boards for wireless signals with different physical characteristics, such as the electric wave EW and the magnetic wave MW. As shown in drawings, the shown effective transmission range RE is one example according to the present invention, and its range can be adjusted, in correspondence with the design and operation of the signal level regulation unit CS and the signal isolation module MS, wherein the effective transmission range RE is substantially located between the two adjacent wireless communication terminals.

In one embodiment, the comb-shaped portion RAC includes an extended linear feeder RAC2, and a plurality of radiation fins RAC4 connected to the extended linear feeder RAC2. The radiation fins RAC4 include a plurality of tips RAC42 (FIG. 4B), and at least a portion of the tips RAC42 in the radiation portion RA is disposed correspondingly to at least a portion of the plural tips RAC42 in another radiation portion RA of the adjacent circuit board (FIG. 4C), for emitting and receiving the electric wave EW between the two radiation portions RA. In one embodiment, the loop antenna RAL is formed by a plurality of loop wires RAL2 located in different conduction layers MS42 in one of the circuit boards, and a plurality of loop pillars RAL4 respectively conducting the loop wires RAL2 (FIG. 5B), to form a conductive loop structure. At least a portion of the loop antenna RAL in the radiation portion RA, is disposed correspondingly to at least a portion of another loop antenna RAL in the adjacent radiating portion RA, to emit and receive the magnetic wave MW between the two radiation portions RA (FIG. 5A).

In one embodiment, the radiation portion RA is coupled to a signal feed point on the circuit board, and the radiation portion RA emits the electric wave EW through the comb-shaped portion RAC, in correspondence with a transmission control signal from a signal feed point. Or, the radiation portion RA is coupled to the signal feed point on the circuit board, and the radiation portion RA emits the magnetic wave MW by the loop antenna RAL, according to the transmission control signal from the signal feed point.

In one embodiment, the tips RAC42 can includes different shapes, such as needle shaped, pointed shape, round end, or pyramid. In one embodiment, the length of the extended linear feeder RAC2, can be substantially proportional to the wavelength of the wireless signal transmitted between the wireless communication terminals.

In one embodiment, the comb-shaped portion RAC is substantially disposed on a plane (for example, on the same layer in the circuit board). Or, based on circuit parasitic or wiring requirements, the comb-shaped portion RAC is substantially disposed on the same plane. The normal direction NR perpendicular to the plane disposing the comb-shaped portion RAC, is substantially parallel to the planar normal direction of the circuit board. In one embodiment, the loop antenna RAL can be substantially disposed on the same plane, or not limitedly to the same plane. The normal direction NR perpendicular to the same plane of the loop antenna RAL, is substantially parallel to the lateral direction of the circuit board, and perpendicular to the planar normal direction NP.

As shown in FIG. 1, in one embodiment, the effective transmission range is in in a form of a long and narrow range. In one embodiment, the effective transmission range RE can be used to indicate the effective communication range of the wireless signal. Physically, the effective transmission range RE is a three-dimensional range, and this three-dimensional range forms a long and narrow range between adjacent wireless signal terminals. The effective transmission range RE of this long and narrow range can isolate other remote wireless signal terminals from the effective transmission range RE. In this way, the effective transmission range RE also defines the signal isolation range of other wireless signal terminals. The effective transmission range RE is a three-dimensional range, located between the adjacent (neighboring) wireless communication terminals, in a form of the long and narrow range. This long and narrow range of the effective transmission range RE, can isolate the farther wireless communication terminals on the circuit boards from this effective transmission range RE. Therefore, the effective transmission range RE also defines a signal isolation range for the farther wireless communication terminals.

In one embodiment, the design of the signal isolation module MS can be decided according to the electric wave EW or the magnetic wave MW of the wireless signal. When the wireless signal is the electric wave EW, the signal isolation module MS includes at least one layer plate structure MS2 (located in the conduction layer(s) outside the comb-shaped portion RAC), which is disposed in the circuit board and parallel to the comb-shaped portion RAC, to determine the effective transmission range RE between the neighboring wireless communication terminals to emit and receive the electric wave EW. In one embodiment, when the wireless signal is the magnetic wave MW, the signal isolation module MS is disposed on an inward-facing side of the radiation portion RA in the circuit board. The signal isolation module MS includes a grid structure MS4 (FIG. 5C, a cross-section view according to cutting line AA in FIG. 5A) disposed on an inward-facing side of the radiation portion RA in the circuit board. The signal isolation module MS includes the grid structure MS4 which including a portion of two conduction layers MS42 in the circuit board and a plurality of shielding pillars MS44 conducting the conduction layers MS42, to determine the effective transmission range RE (FIG. 1) between the wireless communication terminals for emitting and receiving the magnetic wave MW (FIG. 1).

As shown in FIG. 4A, the layer plate structure MS2 shields a portion of the electric wave EW emitted from the radiation portion RA, substantially in the long and narrow range of the effective transmission range RE. In FIGS. 5A and 5C, the grid structure MS4 shields a portion of the magnetic wave MW emitted from the radiation portion RA magnetic wave MW, for mainly shielding the portion of the magnetic wave MW toward the inside of the circuit board, thus to form the long and narrow effective transmission range RE.

In one embodiment, the layer plate structure MS2 is disposed in the conduction layer MS42 of the circuit board, or the conduction layer on the peripheral of the effective transmission range RE corresponding to the comb-shaped portion RAC. A portion of two conduction layers MS42 of the grid structure MS4, can be in the conduction layer on the peripheral of the effective transmission range RE corresponding to the radiation portion RA. The layer plate structure MS2 and the grid structure MS4 can provide a function of securing the wireless signal against being sniffed (illegally recorded from outside), to keep the wireless signal confidential.

As shown in FIGS. 5A, 5B, and 5C, the grid structure MS4 on the circuit board is a single row grid structure (two wireless communication terminals on the same circuit board share this single row grid structure for the signal isolation). If necessary, the grid structure MS4 can be a double row grid structure (each row of the double row grid structure, respectively correspond to two wireless communication terminals on the same circuit board), as shown in FIG. 5D.

As shown in FIGS. 1, 4A, and 5B, in one perspective, the present invention provides a wireless serial connection communication system 10 (or, an antenna module, used in a wireless serial connection communication system 10), which includes: a first circuit board 110, including a first wireless communication terminal; and a second circuit board 120, disposed adjacent to the first circuit board 110, and including a second wireless communication terminal; wherein the first wireless communication terminal is adjacent to the second wireless communication terminal, and each of the wireless communication terminals includes: a radiating portion RA, disposed at a side of each of the circuit boards, and including a comb-shaped portion RAC for emitting an electric wave EW in a lateral direction of the aforementioned circuit boards (a direction NR perpendicular to a normal direction NP of a top surface of the circuit board), to another radiating portion RA of an adjacent circuit board in correspondence with a transmission control signal; or, the radiating portion RA including a loop antenna RAL for emitting and receiving a magnetic wave MW in the lateral direction of the circuit board, to and from another radiating portion RA of the adjacent circuit board, in correspondence with the transmission control signal; and a signal isolation module MS, defining an effective transmission range RE between two adjacent wireless communication terminals to emit and receive the electric wave EW or the magnetic wave MW, wherein the effective transmission range RE is essentially between the first wireless communication terminal on the first circuit board 110, and the second wireless communication terminal on the second circuit board 120.

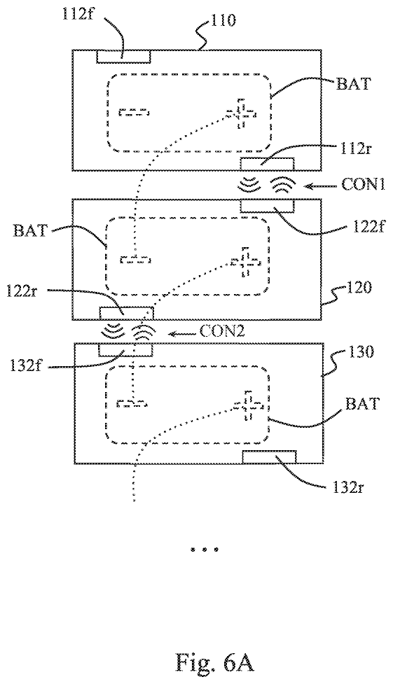

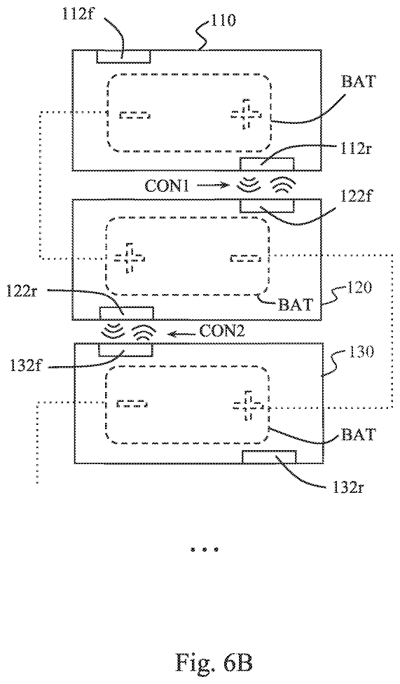

As shown in FIGS. 6A and 6B, in the aforementioned embodiments, the wordings “front” and “rear” of the front wireless communication terminals and the rear wireless communication terminals, are respectively determined according to the numbering order based on the disposition sequence of the circuit boards. For example, the second circuit board 120 behind the first circuit board 110, and the second circuit board 120 is adjacent to the first rear wireless communication terminal 112r of the first circuit board 110, wherein the direction of the first circuit board 110 toward the second circuit board 120 is a “rear” direction; and the direction of the second circuit board 120 toward the first circuit board 110 is the “front” direction (for example, the second front wireless communication terminal 122f toward the first circuit board 110). In a similar fashion, the third circuit board 130 is behind the second circuit board 120, and the rear side of the second circuit board 120 is toward the third circuit board 130. And, the second rear wireless communication terminal 122r is adjacent to the third circuit board 130. The front side of the third front-side wireless signal terminal 132f is toward the second circuit board 120. The front and rear relationship can be not based on the disposition sides on the circuit board corresponding to the two wireless signal terminals, neither the disposition corresponding to the positive and negative electrodes of the battery paired with the circuit board. FIGS. 6A and 6B show the positional relationship between each batteries BAT and the circuit boards 110, 120, and 130 in different embodiments. The scales between each battery and the circuit boards are only for illustrative purpose. The positive and negative electrodes between the adjacent batteries BAT can be serially connected, which are indicated by dotted lines. FIGS. 6A and 6B show an embodiment wherein the batteries BAT are connected in series. If necessary, the batteries BAT can be changed into series-parallel connection or other connection arrangements. Regardless of series connection or series-parallel connection, it does not change the arrangement between the front terminals and the back terminals of each circuit board in this case, which is determined by on the disposition sequence of the circuit boards.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention.

What is claimed is:

1. A wireless serial connection communication system, including:
a first circuit board, including a first antenna module which includes a first front wireless communication terminal and a first rear wireless communication terminal; and
a second circuit board, disposed adjacent to the first circuit board, the second circuit board including a second antenna module which includes a second front wireless communication terminal and a second rear wireless communication terminal;
wherein, the first rear wireless communication terminal is adjacent to the second front wireless communication terminal; and the first front wireless communication terminal and the second rear wireless communication terminal are respectively disposed on farther sides over the first and second circuit boards, with reference to the adjacent disposition of the first rear wireless communication terminal and the second front wireless communication terminal;
wherein, by an antenna operation between the first circuit board and the second circuit board, a first wireless signal connection is built between the first rear wireless communication terminal and the second front wireless communication terminal, and the first wireless signal connection is regulated to be the only wireless signal connection between the first circuit board and the second circuit board.

2. The wireless serial connection communication system according to claim 1, wherein in the first wireless signal connection by the antenna operation, neither the second antenna module nor the first rear wireless communication terminal has wireless signal connection with the first front wireless communication terminal; and neither the first antenna module nor the second front wireless communication terminal has wireless signal connection with the second rear wireless communication terminal.

3. The wireless serial connection communication system according to claim 1, wherein in the first wireless signal connection by the antenna operation, a wireless transmission level between the first front wireless communication terminal and the second antenna module, a wireless transmission level between the first front wireless communication terminal and the first rear wireless communication terminal, a wireless transmission level between the second rear wireless communication terminal and the first antenna module, and a wireless transmission level between the second rear wireless communication terminal and the second front wireless communication terminal, are all lower than a first wireless signal transmission level between the first rear wireless communication terminal and the second front wireless communication terminal on a scale of more than a level threshold, wherein the level threshold confines the first wireless signal connection to be the only wireless signal connection between the first circuit board and the second circuit board.

4. The wireless serial connection communication system according to claim 1, wherein each of the first and second circuit boards includes a signal isolation module or a signal level regulation unit.

5. The wireless serial connection communication system according to claim 4, wherein the signal level regulation unit includes a transmission strength regulation unit, for gradually increasing a signal transmission strength between the first rear wireless communication terminal and the second front wireless communication terminal, until the first wireless signal connection between the first rear wireless communication terminal and the second front wireless communication terminal is determined, to secure the first front wireless communication terminal and the second rear wireless communication terminal against being connected to the first wireless signal connection.

6. The wireless serial connection communication system according to claim 4, wherein the signal level regulation unit includes a signal-to-noise ratio adjustment unit, for gradually increasing the signal-to-noise ratio for receiving the first wireless signal by each of the wireless communication terminals, until the first wireless signal connection is built between the first rear wireless communication terminal and the second front wireless communication terminal, to secure the first front wireless communication terminal and the second rear wireless communication terminal against being connected to the first wireless signal connection.

7. The wireless serial connection communication system according to claim 1, further including a third circuit board disposed adjacent to the second circuit board, the third circuit board including a third front wireless communication terminal and a third rear wireless communication terminal, the second rear wireless communication terminal disposed adjacent to the third front wireless communication terminal, and a second wireless signal connection is built between the second rear wireless communication terminal and the third front wireless communication terminal by the antenna operation.

8. The wireless serial connection communication system according to claim 7, wherein the first wireless signal connection and the second wireless signal connection form a wireless daisy chain.

9. The wireless serial connection communication system according to claim 1, wherein each of the aforementioned wireless communication terminals in each of the aforementioned circuit boards, including:
a radiating portion, disposed at a side of each of the aforementioned circuit boards, the radiating portion including a comb-shaped portion for emitting and receiving an electric wave in a lateral direction of one of the aforementioned circuit boards, to and from another radiating portion of an adjacent circuit board, in correspondence with a transmission control signal; or, the radiating portion including a loop antenna for emitting and receiving a magnetic wave in the lateral direction of the aforementioned circuit board, to and from another radiating portion of the adjacent circuit board, in correspondence with the transmission control signal; and
a signal isolation module, defining an effective transmission range between the aforementioned wireless communication terminals to transmit the electric wave or the magnetic wave.

10. The wireless serial connection communication system according to claim 9, wherein the comb-shaped portion includes an extended linear feeder and a plurality of radiation fins, each of the radiation fins includes a plurality of tips, and at least a portion of the tips is disposed correspondingly to at least a portion of the plurality of tips of another radiation portion; or
the loop antenna is formed by a plurality of loop wires located in different conduction layers in the aforementioned circuit board, and a plurality of loop pillars respectively conducting the loop wires, to form the loop antenna; wherein at least a portion of the loop antenna corresponds to at least a portion of the loop antenna of the other radiating portion.

11. The wireless serial connection communication system according to claim 9, wherein the effective transmission range is in a form of a long and narrow range.

12. The wireless serial connection communication system according to claim 9, wherein the signal isolation module includes a layer plate structure disposed on the circuit board and parallel to the comb-shaped portion, to determine the effective transmission range between the aforementioned wireless communication terminals to emit and receive the electric wave; or, wherein the signal isolation module includes a grid structure disposed on an inward-facing side of the radiation portion in the circuit board, and the signal isolation module includes two conduction layers in the circuit board and a plurality of shielding pillars conducting the conduction layers, to determine the effective transmission range between the aforementioned wireless communication terminals for emitting and receiving the magnetic wave.

13. The wireless serial connection communication system according to claim 12, wherein the layer plate structure shields a portion of the electric wave emitted by the radiation portion; or, the grid structure shields a portion of the magnetic wave emitted by the radiation portion.

14. An antenna module, used in a wireless serial connection communication system, the antenna module including:
a first circuit board, including a first wireless communication terminal; and
a second circuit board, disposed adjacent to the first circuit board, and including a second wireless communication terminal;
wherein the first wireless communication terminal is adjacent to the second wireless communication terminal, and each of the wireless communication terminals includes:
a radiating portion, disposed at a side of each of the circuit boards, and including a comb-shaped portion for emitting and receiving an electric wave in a lateral direction of the aforementioned circuit board, to and from another radiating portion of an adjacent circuit board, in correspondence with a transmission control signal; or, the radiating portion including a loop antenna for emitting and receiving a magnetic wave in the lateral direction of the aforementioned circuit board, to and from another radiating portion of the adjacent circuit board, in correspondence with the transmission control signal; and
a signal isolation module, defining an effective transmission range for transmitting the electric wave or the magnetic wave, wherein the effective transmission range is essentially between the first wireless communication terminal on the first circuit board and the second wireless communication terminal on the second circuit board.
